(19) United States
(12) Patent Application Publication
(10) Pub. No.: US 2002/0156175 A1
(43) Pub. Date: Oct. 24, 2002

(54) Rubber cement for marking unvulcanized rubber and rubber article marked with the same

(75) Inventors: Motoaki Kanoh, Tokyo (JP); Yoshihiro Makino, Tokyo (JP)

Correspondence Address: SUGHRUE MION, PLLC, 2100 Pennsylvania Avenue, NW, Washington, DC, 20037-3213, US

(73) Assignee: BRIDGESTONE CORPORATION

(21) Appl. No.: 10/131,259

(22) Filed: Apr. 25, 2002

Related U.S. Application Data
(62) Division of application No. 09/749,754, filed on Dec. 28, 2000.

(30) Foreign Application Priority Data
Dec. 28, 1999 (JP) 377273/1999

(51) Int. Cl. C08L 1/00

(52) U.S. Cl. 524/492

(57) ABSTRACT

A rubber cement for marking unvulcanized rubber which comprises, as a seed rubber, a rubber composition comprising a rubber component comprising at least one rubber selected from natural rubber and diene rubbers, silica and titanium dioxide.

The rubber cement for marking improves accuracy of the position of placement of rubber members in processes for manufacturing rubber articles such as tires and belts and provides enhanced quality control of the rubber articles.

### BACKGROUND OF THE INVENTION

1. Field of the Invention

The present invention relates to a rubber cement for marking which improves accuracy of the position of placement of rubber members in a process for manufacturing a rubber article such as a tire and a belt and provides enhanced quality control of the rubber articles, and a rubber article marked with the rubber cement.

2. Description of the Related Arts

Using a tire as an example of a rubber article, marking a rubber member in a process for manufacturing a tire will be described. In a process for manufacturing a tire, it is generally practiced that marking lines and/or characters are placed on an extruded tread rubber by applying a colored rubber cement immediately after extrusion of the tread rubber in order to identify the rubber member. However, placing marking lines, characters and/or bar codes directly on the surface of an unvulcanized inner rubber member of a tire has not yet been practiced.

If lines or the like can be placed on the surface of an inner member forming a laminate of rubber (an inner rubber member) in a tire, the correct position of the inner rubber member can be specified easily, and the inner rubber member can be placed more accurately along the central line of the laminate. This can improve the accuracy in the tire building. Moreover, rubber members could be identified easily from each other and the quality assurance in the manufacture of a tire can be enhanced. Therefore, a material used for a marking which is placed on the surface of an inner rubber member forming the laminate (it may be referred to as a material used for an inner marking) has been strongly demanded. However, such a material is a foreign material disposed between inner rubber members forming the laminate and it is difficult that sufficient resistance to cleavage between the inner rubber members forming the laminate is surely obtained. Therefore, the above marking has not been practically applied.

The present inventors have conducted various experiments to satisfy the above demand. As the material for an inner marking, (1) colored pens and paints, (2) sticks of stearic acid and (3) colored rubber cements were selected, and a number of experiments were conducted. As the results, following were found. In the case of (1), a separation took place at the interface between the rubber members and resistance to separation markedly decreased. In the case of (2), the marking lines and the characters showed poor adhesion to the rubber member and were easily fallen away. Moreover, the marking lines and the characters were not sufficiently conspicuous. And in the case of (3), inside of the layer of the rubber cement placed at the interface of the rubber members fractured which caused a deterioration in the resistance to separation. None of the experiments gave any satisfactory results.

### SUMMARY OF THE INVENTION

The present invention to provide a rubber cement for marking which improves accuracy of the position of placement of rubber members in a process for manufacturing a rubber article such as a tire and a belt, and to provide an enhanced quality control of the rubber article and a rubber article marked with the rubber cement.

Among the above three methods, the method (3), which uses a colored rubber cement, appeared to be the most promising. And it was found unexpectedly that, by improving the tensile strength (Tb) and modulus of the elasticity (Mod) of the seed rubber of the rubber cement to be closer to those of the rubber members, which contact the rubber cement, as much as possible, the fracture at the inside of layer of the rubber cement can be prevented. The present invention has been completed based on this unexpected knowledge.

As the first aspect, the present invention provides a rubber cement for marking unvulcanized rubber, which comprises a seed rubber and a solvent. And as the seed rubber, a rubber composition comprising a rubber component comprising at least one rubber selected from natural rubber and diene synthetic rubbers, silica and titanium dioxide. The preferable amount of silica is 10 to 60 parts by weight per 100 parts by weight of the rubber component, and the preferable amount of titanium oxide is 5 to 30 parts by weight per 100 parts by weight of the rubber component.

As the second aspect, the present invention provides a rubber article which has an inner rubber member marked with the rubber cement having a bright color for marking unvulcanized rubber described above as the first aspect of the present invention. The example of the rubber article includes tires, power belts and the like, which have a laminate of rubber. Pneumatic tires can be made according to the constructions disclosed in U.S. Pat. Nos. 5,866,171; 5,876,527; 5,931,211; and 5,971,046, the disclosures of which are incorporated herein by reference. In particular, the rubber cement is applied to lamination of tread materials. The tire has an inner rubber member marked with the rubber cement preferably in an area having a width of about 20% or smaller of a width of a tread portion along a central line of a circumference of the tire. The cement can also be used to form other elastomeric tire components such as subtreads, black sidewalls, body ply skims and the like.

As the third aspect, the present invention provides a process for manufacturing a rubber article which comprises coating a surface of at least one intermediate rubber member, as a mark, with a rubber cement which comprises a solvent and a rubber composition comprising a rubber component comprising at least one rubber selected from natural rubber and diene rubbers, silica and titanium dioxide; laminating the intermediate rubber member with other rubber members in a manner such that the coated surface of the intermediate rubber member contacts the other rubber members; and forming and vulcanizing an obtained laminate.

### BRIEF DESCRIPTION OF THE DRAWINGS

FIG. 1 shows a diagram, which describes an example of the preferable portion S for application of the rubber cement when a tire is selected as the rubber article. In FIG. 1, 1B to 4B mean belts, P means a ply, S means the surface area to which the rubber cement for marking can be applied and T means a tread portion.

### DESCRIPTION OF THE PREFERRED EMBODIMENTS

The rubber cement of the present invention comprises a seed rubber composition comprising a rubber component and a filler, and a solvent.

In the seed rubber composition, the rubber component comprises a diene rubber which is similar to that in inner rubber members so that the properties (in particular, Tb and Mod) of the seed rubber of the rubber cement are improved to be close to those of the inner rubber members and the applied marks are distinctly observable. As the filler, Silica is selected so that Tb and Mod are improved, and titanium dioxide is selected so that the whiteness of the applied rubber cement is enhanced and the mark is more distinctly observable. Of course, other ingredients generally used in formulations of rubber compositions such as white fillers, vulcanization accelerators, vulcanization acceleration activator, vulcanizing agents, antioxidants, silane coupling agents and coloring agents can be suitably selected and used.

The rubber cement of the present invention can be prepared by dissolving the components for the rubber cement into a solvent in accordance with a conventional method. The concentration of the rubber cement is not particularly limited and is selected in accordance with the rubber article to which the rubber cement is applied. When the concentration is excessively low, marks made with the rubber cement are less distinctly observable. When the concentration is excessively high, the operation of application becomes difficult. Therefore, a suitable concentration should be selected.

Preferably the rubber composition comprises from about 10 to about 60 parts by weight of silica per 100 parts by weight of the rubber component. When the amount of silica is less than about 10 parts by weight, the reinforcement effect of silica is may be insufficient. When the amount of silica exceeds about 60 parts by weight, the workability in mixing may deteriorate. Preferably the rubber composition comprises from about 5 to about 30 parts by weight of titanium dioxide per 100 parts by weight of the rubber component. When the amount of titanium dioxide is less than about 5 parts by weight, the whiteness may be insufficient. When the amount of titanium dioxide exceeds about 30 parts by weight, resistance to cleavage may deteriorate.

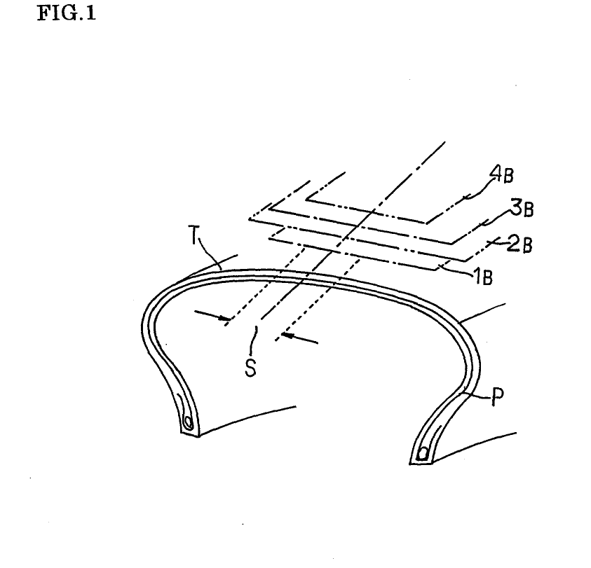

The rubber cement can be applied to various types of rubber articles. As the portion to which the rubber cement is applied, it is preferable that a portion having a smaller internal strain is selected. In the following, a tire is taken as an example of the rubber article and the marking during lamination of tread materials is described. Shearing strains and compressive strains are formed between inner components of the tire while loaded or during rotation of the tire. In general, a strain formed in the central portion of a belt are smaller than that formed at the end portion of the belt. Therefore, the central portion is more suitable for applying the rubber cement. Since the shearing strain increases as going farther from the central line in the axial direction of the tire, it is preferable that the rubber cement is applied in an area having a width of about 20% or smaller of the width of the tread portion along the central line of the circumference of the tire (the surface area S to which the rubber cement for marking can be applied, shown in FIG. 1).

To summarize the advantages of the present invention, by the use of the above rubber cement, sufficient resistance to cleavage between inner rubber members forming a laminate can be exhibited since the tensile strength (Tb) and the modulus of elasticity (Mod) of the seed rubber composition of the rubber cement are increased so that the properties of the rubber cement layer can be made as close as possible to the properties of the rubber members which contact the rubber cement layer. A bright color for the marking is also exhibited by the use of the above rubber cement. The correct positions of the inner rubber members can be easily and specifically decided by the use of the above rubber cement for marking purpose and the rubber articles having more accurate structures.

### EXAMPLES

The present invention will be described more specifically with reference to examples in the following.

The formulations used in Examples of the first aspect of the present invention and Comparative Examples are shown in Table 1. As the rubber article of the second aspect of the present invention, a tire is selected. The test of cleavage between a Carcass ply P and a belt B in a crown portion of the carcass where the tread portion T is placed was conducted and the surface formed by the cleavage was observed. A marking character was placed with a rubber cement on a portion of 1 cm×1 cm along the central line of the surface of a ply treat, and a tire having a size of 11R22.5 and a rib pattern was built and vulcanized. Then, the prepared tire was dissected. The cleavage test between the Carcass ply P and the first belt B1 was conducted and the surface formed by the cleavage was observed. The results of the cleavage test and the observation are shown in Table 1.

### Example 1

The rubber cement of the present invention comprising the rubber component, silica and titanium dioxide was used. The coated portion of the ply treat was remarkably white as expected. In the test of cleavage of the tire, the rubber cement was not exposed to the surface and the rubber surrounding the rubber cement was broken in the form of the aggregate fracture. The results showed that the excellent adhesion was achieved. In the test of cleavage after the LR drum test for 40,000 km, the surface formed by the cleavage was observed and it was shown that the rubber surrounding the rubber cement was broken in the form of the aggregate fracture. The results are shown in Table 1. The LR (Long Run) drum test is for a measurement of durability of a tire, which is measured by running a tire on a drum at a speed of 60 km/hour for a distance of 40000 km.

### Comparative Examples 1 and 2

A rubber cement for marking lines on tread rubbers and a white side rubber used for passenger car tires (PSR), which were available in a tire production plant, were used as the rubber cement for marking. In the test of cleavage, the fracture occurred within the rubber cement and the resistance to cleavage decreased markedly to about 1/4 of the ordinary value. The durability of the tire was also insufficient. The results are shown in Table 1.

### Comparative Example 3

A rubber cement containing silica but no titanium dioxide was used. Silica was used in an amount of 65 parts by weight per 100 parts by weight of the rubber component. Although an excellent result was obtained in the test of cleavage, the workability by a Banbury mixer was markedly poor. Moreover, since titanium dioxide was not contained, the whiteness of the mark was insufficient. Therefore, the rubber cement was not suitable for the cement for marking. The results are shown in Table 1.

TABLE 1

| | | | | |
|---|---|---|---|---|
| Example | 1 | | | |
| Comparative | | 1 | 2 | 3 |
| Example | | | | |

Formulation

| | | | | |
|---|---|---|---|---|
| RSS #3¹⁾ | 100 | 100 | 20 | 100 |
| Cl-IIR²⁾ | 0 | 0 | 50 | 0 |
| EPDM³⁾ | 0 | 0 | 30 | 0 |
| SiO₂ | 40 | 0 | 0 | 65 |
| CaCO₃ | 0 | 60 | 0 | 0 |
| TiO₂ | 10 | 40 | 40 | 0 |
| Clay | 0 | 0 | 20 | 0 |
| Talc | 0 | 0 | 30 | 0 |
| ZnO | 6 | 10 | 4 | 6 |
| Stearic acid | 2 | 2 | 2 | 2 |
| Ultramarine blue | 0 | 0 | 0.5 | 0 |
| Distinctness of | excellent | excellent | good | poor |
| formed mark⁴⁾ | | | | |
| Test of cleavage | | | | |
| (Condition of | | | | |
| surface formed | | | | |
| by cleavage) | | | | |
| original tire | rubber | rubber | rubber | rubber |
| | cement | cement | cement | cement |
| | not exposed, | exposed, | exposed, | not exposed, |
| | aggregate | fracture | fracture | aggregate |
| | fracture of | of rubber | of rubber | fracture of |
| | surrounding | cement | cement | surrounding |
| | rubber | | | rubber |
| tire after driving | the same | the same | the same | the same |
| for 40,000 km on | as | as | as | as |
| a LR drum | the above | the above | the above | the above |

¹⁾Natural rubber
²⁾Chlorinated butyl rubber
³⁾Ethylene-propylene-diene terpolymer rubber
⁴⁾excellent: remarkably distinct whiteness
good: distinct whiteness, though less than the above
poor: obscure whiteness

Only Example 1, which has both silica and titanium dioxide in its formulation, provides a combination of acceptable properties for use as a rubber cement according to the present invention.

What is claimed is:

1. A rubber cement for marking unvulcanized rubber which comprises, as a seed rubber, a rubber composition comprising a rubber component comprising at least one rubber selected from natural rubber and diene rubbers, a filler comprising silica and titanium dioxide.

2. A rubber cement according to claim 1, wherein the rubber composition comprises from about 10 to about 60 parts by weight of silica per 100 parts by weight of the rubber component.

3. A rubber cement according to claim 1, wherein the rubber composition comprises from about 5 to about 30 parts by weight of titanium dioxide per 100 parts by weight of the rubber component.

4. A rubber article which has an inner rubber member marked with a rubber cement having a bright color which comprises, as a seed rubber, a rubber composition comprising a rubber component comprising at least one rubber selected from natural rubber and diene rubbers, silica and titanium dioxide.

5. A rubber article according to claim 4, wherein the rubber composition comprises from about 10 to about 60 parts by weight of silica per 100 parts by weight of the rubber component.

6. A rubber article according to claim 4, wherein the rubber composition comprises from about 5 to about 30 parts by weight of titanium dioxide per 100 parts by weight of the rubber component.

7. A rubber article according to claim 4, which is a tire.

8. A rubber article according to claim 7, wherein the tire has an inner rubber member marked with the rubber cement in an area having a width of about 20% or smaller of a width of a tread portion along a central line of a circumference of the tire.

9. A process for manufacturing a rubber article which comprises coating a surface of at least one intermediate rubber member, as a mark, with a rubber cement which comprises a solvent and a rubber composition comprising a rubber component comprising at least one rubber selected from natural rubber and diene rubbers, silica and titanium dioxide; laminating the intermediate rubber member with other rubber members in a manner such that the coated surface of the intermediate rubber member contacts the other rubber members; and forming and vulcanizing an obtained laminate.
